(19) United States
(12) Patent Application Publication
(10) Pub. No.: US 2024/0295414 A1
(43) Pub. Date: Sep. 5, 2024

(54) REALTIME-CAPABLE RAINFLOW COUNTING METHOD

(71) Applicant: ZF Friedrchshafen AG, Friedrichshafen (DE)

(72) Inventors: Christian Riess, Wangen (DE); Martin Obermayr, Friedrichshafen (DE); Dietmar Tilch, Marktheidenfeld (DE); Daniel Wolf, Friedrichshafen (DE)

(73) Assignee: ZF Friedrchshafen AG, Friedrichshafen (DE)

(21) Appl. No.: 18/042,717

(22) PCT Filed: Aug. 4, 2021
(86) PCT No.: PCT/EP21/71762

§ 371 Date: Feb. 23, 2023

(30) Foreign Application Priority Data
Sep. 2, 2020 (DE) 10 2020 211 058.1

(51) Int. Cl. G01D 1/14

(52) U.S. Cl. CPC G01D 1/14

(57) ABSTRACT

A method for determining load cycles uses a first buffer containing a first value of a physical variable in a first position and a second value thereof in a second position. A measured third value is stored in a third position. A Rainflow filter is applied, it is checked whether a point of inflection results between the first value and the third value. If the second value forms a point of inflection, then the first position is overwritten with the second value, the second position is overwritten with the third value, the second value is discretized and stored as the last entry in a second buffer. If a second-from-last entry and third-from-last entry form a load cycle, then these values are registered in a Rainfall matrix and removed from the second buffer, and the second buffer is again checked for a load cycle.

### RELATED APPLICATIONS

This application claims the benefit under 35 U.S.C. § 371 as a U.S. National Phase Application of application no. PCT/EP2021/071762, filed on 4 Aug. 2021, which claims the benefit of German Patent Application no. 10 2020 211 058. 1 filed 2 Sep. 2020, the contents of which are hereby incorporated herein by reference in their entireties.

### FIELD OF THE DISCLOSURE

The invention relates to a method for determining load cycles, a computer program configured to carry out the method, a computing device, and a vehicle.

### BACKGROUND

So-termed rainflow counting methods are known from the prior art. These serve to register load cycles. With reference to the registered load cycles the operational strength of components can be assessed.

### SUMMARY

Basically, a distinction is made between three-point and four-point algorithms. Three-point algorithms are real-time-capable to a limited extent. In contrast, real-time-capable four-point algorithms are not known.

The purpose of the present invention is to provide a real-time-capable method for registering load cycles. This objective is achieved by a method for determining a load cycle, a computer program for carrying out the method, a computing device configured to carry out the method, and a vehicle. Preferred further developments will be apparent from the following description and from the example embodiment illustrated in FIG. 1.

The method according to the invention is computer-implemented. This means that at least one and preferably all the steps of the method are carried out by a computing device.

The method serves to register load cycles. A load cycle describes the time variation of a physical variable. The variable is correlated with a degree of material fatigue. Since the time variation of a value of the physical variable is measured, evaluated, and registered, conclusions can be drawn about a degree of material fatigue and thus about the operational durability of the component concerned.

The physical variable is preferably a force or a torque which acts upon the component, or a temperature of the component.

The method according to the invention uses a first buffer and a second buffer. A buffer is understood to be a memory of a computing device which serves for the intermediate storage of data.

The first buffer serves for the intermediate storage of values of the above-mentioned physical variable. Thus, a first value x₁ of the physical variable is stored in a first position in the buffer. A second value x₂ of the physical variable is stored in a second position in the buffer. Preferably the first buffer is initialized in such manner, i.e. the first value x₁ and the second value x₂ of the physical variable are already stored respectively in the first and second positions in the first buffer before the process of carrying out the method according to the invention or an iteration of the method begins.

The method provides that a third value x₃ of the physical variable is measured and stored in a third position in the buffer.

To the first value x₁, the second value x₂ and the third value x₃ of the physical variable a rainflow filter is applied. This tests whether the second value x₂ forms a point of inflexion between the first value x and the third value x₃. In detail, it is checked whether a difference x₁−x₂ between the first value x₁ and the second value x₂ has the same sign as a difference x₃−x₂ between the third value x₃ and the second value x₂ and both differences are quantitatively above a predefined threshold value ω, also called the filter width. Thus, it is checked whether |x₁−x₂|>ω<|x₃−x₂|. The threshold value ω is a constant. In particular, the threshold value is the same in each iteration of the method.

If the second value x₂ does not form a point of inflexion, the second position in the buffer, where the second value x₂ was previously stored, is overwritten with the third value x₃. In the event of a subsequent iteration of the method, the third value x₃ then becomes the second value. The first value x₁ stored in the first position of the first buffer is retained.

Otherwise, i.e. if the second value x₂ does form a point of inflexion, the first position of the first buffer is overwritten with the second value x₂ and the second position of the first buffer is overwritten with the third value x₃. In a subsequent iteration the second value x₂ then becomes the first value. Correspondingly, the third value x₃ then becomes the second value.

Before a subsequent iteration begins, if necessary, the second value x₂ is processed further in discretized form. The discretizing of the second value x₂ takes place by using a function s: x∈ [symbol] →s∈{1, . . . , n}, with a number n of classes. The function s assigns to the second value x₂ the number s(x₂) of a class. This number is used as the discretized form of the second value x₂. In its discretized form the second value is stored as the last entry s₄ in the second buffer.

The entries in the second buffer are identified with reference to the sequence of their entry. Besides the last entry s₄ the second buffer contains a second-from-last entry s₃, a third-from-last entry s₂ and a fourth-from-last entry s₁. The fourth-from-last entry s₁ was stored in the second buffer before the third-from-last entry s₂. In turn, the third-from-last entry s₂ was stored in the second buffer before the second-from-last entry s₃, and correspondingly the second-from-last entry s₃ was stored in the second buffer before the last entry s₄.

With reference to the last entry s₄, the second-from-last entry s₃, the third-from-last entry s₂ and the fourth-from-last entry s₁ in the second buffer, it is checked whether the second-from-last entry s₃ and the third-from-last entry s₂ form a load cycle. This preferably takes place with reference to a fourfold condition applied to the last four entries s₁, s₂, s₃ and s₄. In detail, it is checked whether the relationship:

$$\vert {s}_{1} - {s}_{2} \vert \geq \vert {s}_{2} - {s}_{3} \vert \leq \vert {s}_{3} - {s}_{4} \vert$$

holds good.

If that condition is satisfied, the second-from-last entry s₃ and the third-from-last entry s₂ in the second buffer form a load cycle.

The load cycle or the second-from-last entry s₃ and the third-from-last entry s₂ are registered in a rainfall matrix. Corresponding matrixes and registration methods are known from the prior art. The matrix used in the present case is a matrix with n lines and n columns. All the fields of the matrix are initialized with 0 before an iteration of the method according to the invention is carried out for the first time. To register the load cycle, the field (s₂, s₃) of the matrix is incremented by 1.

Finally, the second-from-last entry s₃ and the third-from-last entry s₂ are removed from the second buffer. Consequently, in a subsequent iteration of the method the fourth-from-last entry s₁ becomes the second-from-last entry, a fifth-from-last entry becomes the third-from-last entry and a sixth-from-last entry becomes the fourth-from-last entry in the second buffer.

The above-described checking of the second buffer for a load cycle is repeated iteratively until no further load cycle is contained in the second buffer. Owing to the prior discretization of the second value x₂ of the physical variable, the maximum number of entries in the second buffer is limited to 2n−1.

According to the method described, the third value x₃ of the physical variable is processed directly. This makes the method particularly efficient in terms of memory and computing capacity. In particular, the method can be carried out in real time on vehicle control units.

In a preferred further development, the method is carried out iteratively. This means that the individual process steps are repeated in an iteration loop. At the start of every loop a new value of the physical variable is measured, and this is processed further as the third value x₃.

To initialize the first buffer and the second buffer, in a preferred further development the value of the physical variable is measured and stored in the first buffer in the first position and in the second position. In that way the process begins with a first buffer which contains the same value of the physical variable in its first, second and third positions.

A computer program according to the invention is designed to enable a computing device to carry out the method according to the invention or a preferred further development thereof. Specifically, the computing device is enables to do that when the computer program is run on the computing device.

A computing device according to the invention comprises at least one interface. The computing device is designed-possibly by means of a computer program according to the invention-to carry out the method according to the invention or a preferred further development thereof. For this, the third value x₃ of the physical variable is read in via the interface.

A vehicle according to the invention comprises at least one sensor. This sensor serves to measure the third value x₃. The vehicle comprises a computing device according to the invention. By way of its interface the sensor is connected to exchange signals. Thus, the third value x₃ measured by the sensor is delivered via the interface of the computing device for further processing by carrying out the method according to the invention or a preferred further development thereof.

### BRIEF DESCRIPTION OF THE DRAWING

A preferred example embodiment of the invention is illustrated in the figure. Specifically, FIG. 1 shows:

FIG. 1: A flow chart of a method for determining a load cycle, in accordance with an embodiment of the present disclosure.

### DETAILED DESCRIPTION

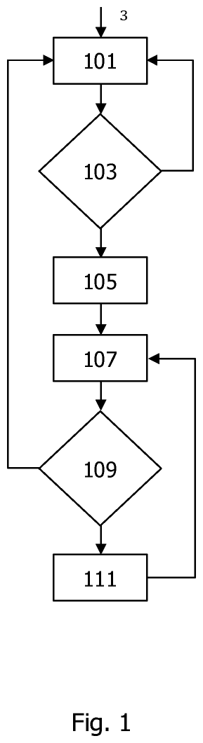

FIG. 1 makes clear the process steps of a real-time algorithm for rainflow counting. The algorithm comprises a plurality of part-steps 101, 103, 105, 107, 109, 111.

In a first part-step 101 a measured value x₃ of a physical parameter is introduced as input into the process. The measured value x₃ is stored in the third position in a first buffer.

In a second part-step 103 a rainflow filter is used on the values contained in the first buffer. During this step it is checked whether a value x₂ stored in a second position of the first buffer is a point of inflection between a value x₁ stored in a first position of the first buffer and the value x₃ stored in the third position in the first buffer. If that is not the case, the value x₂ contained in the second position of the first buffer is overwritten with the value x₃ previously stored in the third position in the first buffer. Thereafter, a new value of the physical variable is measured and stored in the third position in the first buffer.

If a point of inflection has been recognized in the second position of the first buffer, then the value x₂ stored therein is discretized in a third part step 105.

In a fourth part-step 107, in its discretized form the value x₂ is added to a second buffer.

In a fifth part-step 109 the last four entries in the second buffer are checked in relation to a four-point condition. This makes it possible to ascertain whether a second-from-last entry and a third-from-last entry in the second buffer form a load cycle.

If the second-from-last entry and the third-from-last entry form a load cycle, in the sixth part-step 111 the two entries are registered in a Rainfall matrix and erased from the second buffer. In that case the entries in the second buffer are again checked in relation to a four-point condition. Otherwise, the process of the method springs back from the fifth part-step 109 to the first part-step 101.

### INDEXES

101 First part-step
103 Second part-step
105 Third part-step
107 Fourth part-step
109 Fifth part-step
111 Sixth part-step

1-6. (canceled)

7. A computer-implemented method for determining load cycles, wherein a first buffer contains a first value (x₁) of a physical variable in a first position and a second value (x₂) of the physical variable in a second position, and wherein a third value (x₃) of the physical variable is measured and stored in a third position in the first buffer, the method comprising:
applying the Rainflow filter to the second value (x₂);
overwriting the first position of the first buffer with the second value (x₂); and
overwriting the second position of the first buffer with the third value (x₃);
discretizing the second value (x₂) to determine a discretized form;
storing the discretized form as a last entry (s₄) in a second buffer and,
determining whether a second-from-last entry (s₃) and a third-from-last entry (s₂) form a load cycle, with reference to a last entry (s₄), the second-from-last entry (s₃), the third-from-last entry (s₂), and a fourth-from-last entry (s₁) in the second buffer;
determining that the second-from-last entry (s₃) and the third-from-last entry (s₂) form a load cycle;
registering the second-from-last entry (s₃) and the third-from-last entry (s₂) in a Rainfall matrix; and
removing the second-from-last entry (s₃) and the third-from-last entry (s₂) from the second buffer; and
re-checking whether the second-from-last entry (s₃) and the third-from-last entry (s₂) of the second buffer form a load cycle.

8. The method according to claim 7, wherein the method is carried out iteratively.

9. The method according to claim 8, further comprising:
measuring a value of the physical variable to determine a measured value; and
initializing the first position and the second position of the first buffer using the measured value.

10. A computer-implemented method for determining load cycles, wherein a first buffer contains a first value (x₁) of a physical variable in a first position and a second value (x₂) of the physical variable in a second position, and wherein a third value (x₃) of the physical variable is measured and stored in a third position in the first buffer, the method comprising:
applying the Rainflow filter to the second value (x₂);
determining that the second value (x₂) does not form a point of inflection; and
overwriting the second position in the first buffer with the third value (x₃).

11. A computer program product containing executable code that when executed by a computer performs the method of claim 7.

12. A computing device configured to execute the method of claim 7, the computing device comprising at least one interface configured to read in the third value (x₃) of the physical variable.

13. A vehicle comprising:
at least one sensor; and
a computing device with an interface, the computing device configured to execute the method of claim 7, wherein the sensor is disposed in communication with the computing device via the interface.
